(19) United States
(12) Patent Application Publication
(10) Pub. No.: US 2006/0097503 A1
(43) Pub. Date: May 11, 2006

(54) Seat belt tongue

(75) Inventors: Yasuhiro Kiyomizu, Kyoto-shi (JP); Tadayuki Asako, Echi-gun (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/264,016

(22) Filed: Nov. 2, 2005

(30) Foreign Application Priority Data
Nov. 5, 2004 (JP) 2004-322216

(51) Int. Cl. B60R 22/00; A44B 11/25

(52) U.S. Cl. 280/801.1; 297/474; 24/628

(57) ABSTRACT

A tongue may include an engaging strip to be inserted into and engaged with a buckle and a gripper for supporting the engaging strip. The gripper may include an upper cover that includes an upper surface portion which rises upward in a spherical shape, an upper surface portion of a planer shape formed continuously so as to incline from the upper surface portion of spherical shape, and an arcuate flange provided on the outer peripheral edge of the upper surface portion of spherical shape. An engaging strip of the tongue may project from an outer peripheral edge of the upper surface portion that has a planar shape. The gripper of the tongue may be formed generally into a round shape, which fits a palm of a passenger.

### BACKGROUND

The present invention relates to a tongue used for a seatbelt apparatus for a passenger seated on a seat of a vehicle such as a motor vehicle and a safety belt apparatus for personnel in a work site.

The present invention also relates to a seat belt apparatus provided with a tongue on which a tongue cover can be mounted or is provided.

For example, a seat belt apparatus to be mounted to a vehicle, such as a motor vehicle, is known as a seat belt. The seat belt apparatus is used to aid in constraint movement of the passenger when a large speed reduction occurs, such as when minor collision with the vehicle occurs. In the related art, for example a three-point seat belt apparatus is known as one of such conventional types of seatbelt apparatus. Japanese Patent No. 3055228 (incorporated by reference herein) illustrates an example of a such a seat belt apparatus.

FIG. 6 is a schematic perspective view of a three-point seatbelt apparatus disclosed in Japanese Patent No. 3055228. In the drawing, reference numeral 1 denotes a seat belt apparatus associated with a vehicle seat 2, reference numeral 3 is a seat belt retractor fixed to a vehicle body near the vehicle seat 2 for withdrawably winding the seat belt 4 in the normal state and disabling withdrawing of the seat belt 4 in case of emergency, reference numeral 5 denotes a tongue slidably supported by the seat belt 4, reference numeral 6 denotes a buckle fixed to the vehicle seat 2 or the vehicle body for engaging the tongue 5, and reference numeral 7 denotes a belt guide mounted on the upper side portion of the vehicle such as a center pillar for guiding the seat belt 4 withdrawn from the seat belt retractor 3. A belt anchor 4a at a distal end of the seat belt 4 withdrawn from the seatbelt retractor 3 is fixed to the vehicle seat 2 or the vehicle body.

With seat belt apparatus 1, when a passenger seated on the vehicle seat 2 fastens the seat belt 4, the passenger withdraws the seat belt 4 from the seatbelt retractor 3, engages the tongue 5 with the buckle 6, and releases his/her hand from the tongue 5, whereby part of the seatbelt 4 that is excessively withdrawn is retracted by the seat belt retractor 3 to minimize sagging of the seat belt 4, and the seatbelt 4 is fastened on the passenger.

The tongue 5 used on the seatbelt apparatus in the related art, as shown in FIG. 7, includes a metallic engaging strip 5a having an engaging hole 5a1 which is engaged with the buckle 6 when a latch member (not shown) comes into engagement with the engagement hole 5a1 when the tongue 5 is inserted into the buckle 6. The tongue 5 includes a grip portion 5b of molded resin, with part of the engaging strip 5a and a gripper 5b arranged to be gripped for inserting and engaging the tongue 5 into/with the buckle 6. In this case, by the seatbelt 4 being passed through a belt through hole 5b1 formed on the gripper 5b, the tongue 5 is slidably supported by the seatbelt apparatus 4.

In the case of the tongue 5 as described above, the engaging strip 5a is formed of a metallic plate, as shown in FIG. 7, and the gripper 5b is formed of molded resin in a flat and substantially rectangular shape.

However, when the gripper 5b of the tongue 5 is formed into the flat and rectangular shape, the gripper 5b does not fit well to the passenger's hand when the passenger grips the gripper 5b for inserting and engaging into/with the buckle 6. Therefore, there are problems not only in that the passenger feels a sense of discomfort, but also in that the gripper 5b cannot be easily gripped.

There are also similar problems in the case of a tongue that is used for the safety belt apparatus for personnel in a work site or the like, such as in a vehicle for a work site.

### SUMMARY OF THE INVENTION

According to an embodiment of the present invention, a seat belt tongue includes a gripper and an engaging strip projecting from the gripper, wherein the gripper is arranged to be slidably supported by a safety belt, wherein the engaging strip is arranged to be inserted into and engaged with a buckle, wherein a portion of an outer peripheral surface of the gripper is formed into a curved arc, wherein a second portion of the outer peripheral surface is arranged so that the engaging strip projects from the second portion, wherein the second portion is formed into a chord that is continued from the curved arc, wherein a surface of the gripper forms a curved surface of a curved swelling shape and a planer surface formed continuously from the curved surface, and wherein the curved surface is provided on a portion formed continuously from the outer peripheral surface formed into the shape of the curved arc, and the planer surface is formed to be continued from the outer peripheral surface formed into the linear chord and to be inclined from the outer peripheral surface formed into the chord toward the swelling direction of the curved surface and away from the engaging strip.

According to an embodiment of the present invention, a seat belt tongue includes a metallic tongue plate including an engaging strip and a through hole for a safety belt and a resin molded portion, wherein the resin molded portion is molded on a portion of the tongue plate with the through hole, wherein the tongue plate is formed into a T-shape, a lower cover arranged to support the resin molded portion and the tongue plate, and an upper cover arranged to detachably engage with the lower cover so as to cover the resin molded portion.

According to an embodiment of the present invention, a seat belt apparatus includes a seatbelt, a seatbelt retractor for retracting the seatbelt, a tongue slidably supported by the seatbelt, and a buckle, wherein the tongue is arranged to be inserted and engaged with the buckle, wherein the seat belt is arranged to be fastened on a passenger when the tongue is inserted into and engaged with the buckle, wherein the tongue includes a tongue plate that includes an engaging strip and a through hole for a safety belt and a resin molded portion, wherein the resin molded portion is molded on a portion of the tongue plate with the through hole, wherein the tongue plate is formed into a T-shape, a lower cover arranged to support the resin molded portion and the tongue plate, and an upper cover arranged to detachably engage with the lower cover so as to cover the resin molded portion.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is an exploded perspective view showing an example of an embodiment of a tongue according to the present invention.

FIG. 2 is a perspective view of a buckle of the tongue in this example in an assembled state.

FIG. 3 is a general perspective view of the tongue in this example in the assembled state.

FIG. 4 is a general perspective view showing an example of the buckle which the tongue of this example is inserted to and engaged with.

FIG. 5 is a drawing showing a state in which the tongue and the buckle in this example is inserted and engaged with respect to each other.

FIG. 6 is a perspective view showing an example of a three-point seat belt apparatus in the related art.

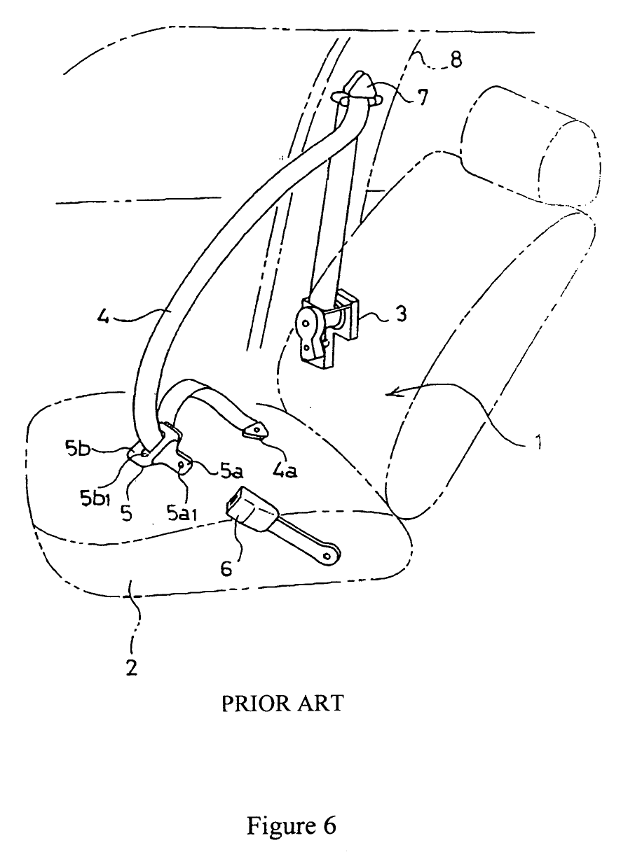

FIG. 7 is a perspective view showing a tongue of the seatbelt apparatus shown in FIG. 6.

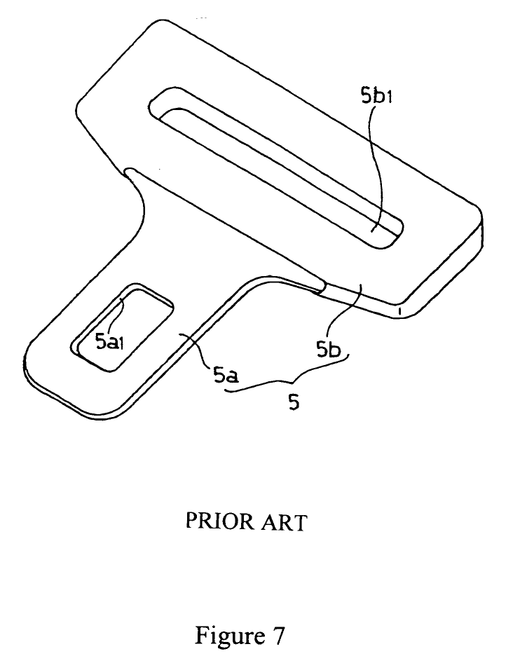

### DETAILED DESCRIPTION

Embodiments of the present invention will be described below with reference to the drawings.

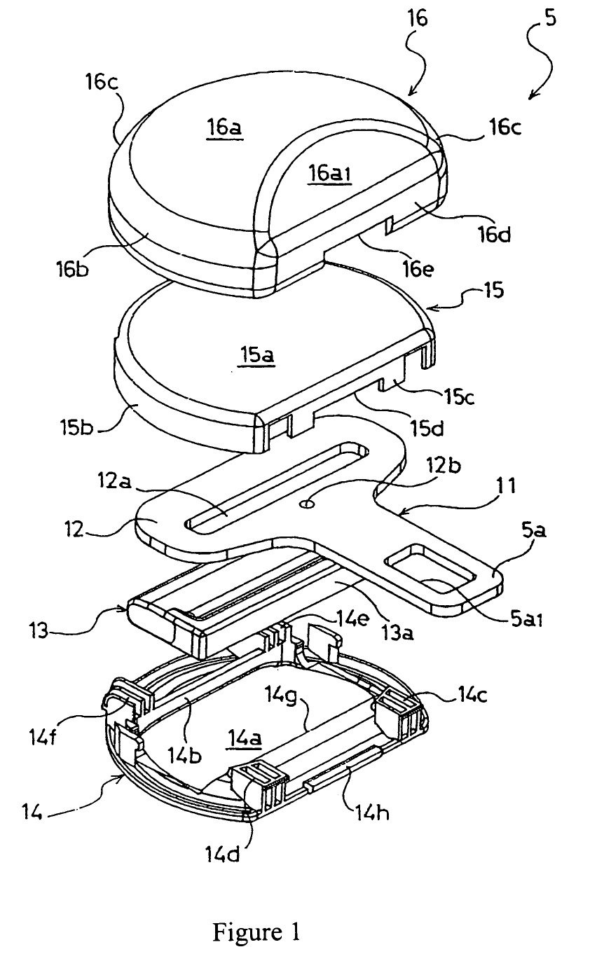

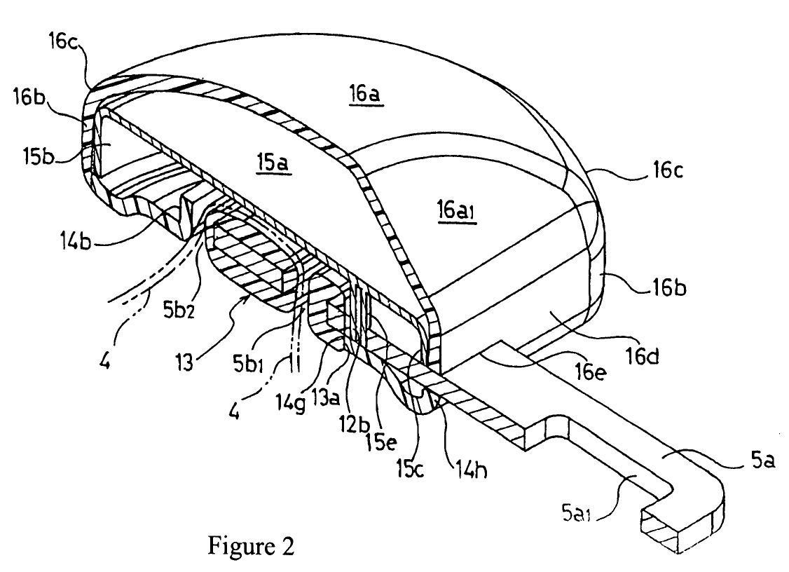

FIG. 1 is an exploded perspective view showing an example of an embodiment of a tongue according to the present invention, and FIG. 2 is a perspective view of a buckle of the tongue in this example in an assembled state, taken along the insertion direction thereof. In the description below, the components which are the same as previous embodiments or the above-described example of the related art are represented by the same reference numerals and detailed description thereof will not be made.

As shown in FIG. 1, the tongue 5 of this embodiment includes a tongue plate 11 formed of a metal plate. The tongue plate 11 is formed into a shape elongated in the direction for insertion of a buckle 6, and is arranged in substantially a T-shape, consisting of the engagement strip 5a to be engaged with the buckle 6 and a body portion 12 formed in a shape elongated in a direction orthogonal to the direction of insertion of the buckle 6 for securing the strength of the gripper 5b of the tongue. The engaging strip 5a is formed with an engaging hole 5a1 with which a latch member of the buckle 6 engages as in the case of the related art described above, and the body portion 12 is formed with an elongated through hole 12a extending in a direction orthogonal to the direction of insertion of the buckle 6 for allowing passage of the seatbelt 4.

As shown in FIG. 2, the body portion 12 is molded with resin as in the case of the related art, and is covered by a flat and rectangular resin molded portion 13. In this case, the through-hole 12a of the body portion 12 may also be molded with resin, and the resin molded portion 13 may be formed with a belt through hole 5b1 to allow passage of the seat belt 4. The resin molded portion 13 may be reinforced by the body portion 12, so that the strength of the resin molded portion 13 is secured.

The body portion 12 and the resin molded portion 13 may be placed on and supported by a lower cover 14 formed, for example, of opaque resin to have a substantially annular shape. The lower cover 14 can also be formed of transparent resin, or of a material other than resin, such as a light metal. The resin molded portion 13 is adapted to be arranged in an opening 14a at a center of the lower cover 14. In this manner, in a state in which the resin molded portion 13 is arranged in the opening 14a, another belt through hole 5b2 may be defined by an edge of the resin molded portion 13 on the opposite side from the engaging strip 5a and by a guide portion 14b of the lower cover 14. The belt through hole 5b2 may be formed into an elongated hole extending in parallel with, and in substantially the same size as, the belt through hole 5b1 formed on the resin molded portion 13.

The middle cover 15, which may be formed of opaque resin, may be placed so as to cover the body portion 12, resin molded portion 13, and part of the lower cover 14 from above. The upper surface portion 15a of the middle cover 15 may be formed into a plate shape having an arcuate outer peripheral edge, and the arcuate outer peripheral edge is formed with an arcuate flange 15b, and the arcuate flange 15b comes into contact with the outer peripheral end of the upper surface of the lower cover 14. The outer peripheral edge of the upper surface portion 15a of the middle cover 15 where the engagement strip 5a projects may be formed into a linear chord shape, and a linear flange 15c may be formed on the chord-shaped outer peripheral edge. A rectangular notch 15d may be formed on the linear flange 15c, so that the upper surface and the left and right side edge of the engagement strip 5 are fitted to the recess 15d with a small clearance or without clearance. In addition, the middle cover 15 may be formed with a cylindrical column 15e adapted to be fitted to and engaged with an engaging hole 12b formed on the body portion 12.

The upper cover 16 of transparent resin may be placed so as to cover the middle cover 15 from above. The upper surface portion 16a of the upper cover 16 may include an arcuate outer peripheral edge and be formed into a spherical shape that has an upward, convex or dome shape that swells upwards. The upper cover 16 may include an arcuate flange 16b that is continuously formed on the arcuate outer peripheral edge in the vertical direction. In this case, the size of the sphere swelling upwardly of the upper surface portion 16a is set to a size that fits an average size of a human palm, and the diameter of the arc of the flange 16b is set to exactly or substantially fit five fingers of a human hand with an average size. The shape from the upper surface portion 16a to the flange 16b does not change abruptly, but changes gently to form an R-portion (curved surface portion) 16c in a relatively large radius. The inner peripheral surface of the arcuate flange 16b may be arranged to abut against the outer peripheral surface of the lower cover 14 and the outer peripheral surface of the arcuate flange 15b of the middle cover 15.

The outer peripheral edge of the upper surface portion 16a of the upper cover 16 where the engaging strip 5a projects is formed into a chord shape, and a linear flange 16d may be formed on the chord-shaped outer peripheral edge in the vertical direction. The linear flange 16d may be formed with a rectangular recess 16e so that the upper surface and the left and right side edges of the engaging strip 5a exactly or substantially fits in the recess 16e without clearance or with minimal clearance.

The inner peripheral surface of the linear flange 16d may abut against the outer peripheral surface of the lower cover 14 where the engaging strip 5a projects and against the outer peripheral surface of the linear flange 15c of the middle cover 15. In addition, the upper surface portion 16a1 formed continuously from the linear flange 16d may be formed so as to incline toward the swelling direction of the spherical shape and away from the engaging strip 5a, and may be formed continuously from the upper surface portion 16a of the spherical shape.

The upper cover 16 may be mounted to a lower cover 14 by detachably engaging an engaging portion, not shown, with the engaged portions 14c, 14d, 14e, 14f of the lower cover 14, for example, by snap engagement or the like. The gripper 5b of the tongue 5 including the resin molded portion 13 and the respective covers 14, 15, 16 may be formed in this manner.

In a state in which the upper cover 16 is mounted to the lower cover 14, the middle cover 15 may be clamped between the upper cover 16 and the lower cover 14. In addition, the edge 13a of the resin molded portion 13 on the side of the engaging strip 5a may come into abutment with the edge 14g of the lower cover 14 formed with the opening 14a on the side of the engaging strip 5a. The cylindrical column 15e of the middle cover 15a may be arranged to fit the engaging hole 12b of the body portion 12, whereby the tongue plate 11 and the resin molded portion 13 are positioned with respect to the respective covers 14, 15, 16. Then, the engaging strip 5a is firmly clamped between the two linear flanges 15c, 16d and the engaging strip supporting portion 14h of the lower cover 14. In this manner, assembly of the tongue 5, including the gripper 5b and the engaging strip 5a, may be completed.

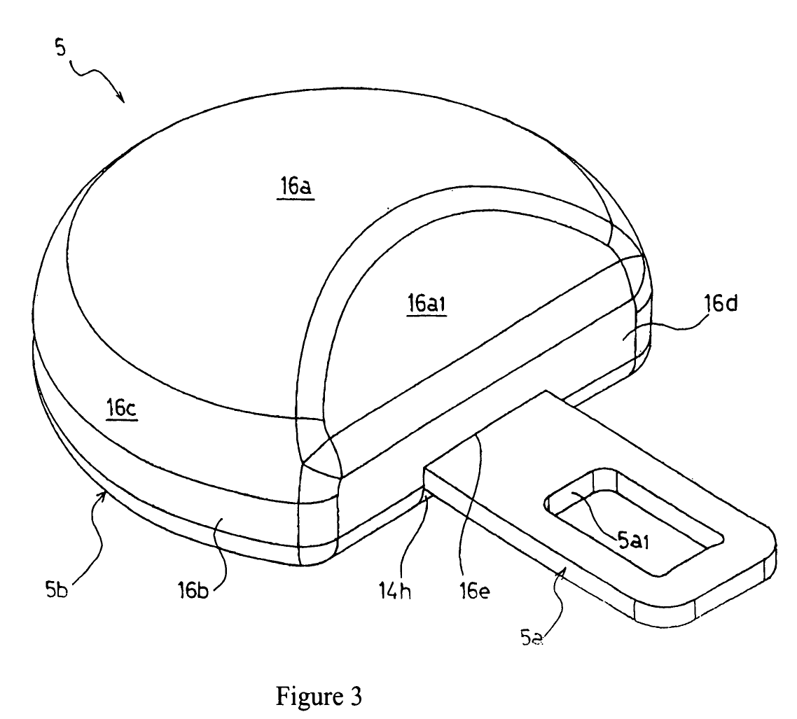

As shown in FIG. 3, the upper surface portion 16a which swells upwardly in the spherical shape of the gripper 5b of the completed tongue 5 may fit the palm of the passenger, and the outer peripheral surface including the arcuate flange 16b and the R-portion 16c thereof may fit the five fingers of the passenger when two joints of the respective fingers are bent to a moderate degree, thereby providing a contour so as to allow the passenger to grip the gripper 5b easily by hand. The engaging strip 5a of the tongue 5 may project from the gripper 5b. The planar portion 16a1 may essentially truncate the swelling or dome shaped portion of the upper surface 16a.

As shown in FIG. 2, the seatbelt 4 extending from the belt anchor 4a and fixed to the floor portion or the like of the vehicle body may extend through the belt through hole 5b1, a space between the upper surface portion 15a of the middle cover 15 and the resin molded portion 13, and the belt through hole 5b2 to the belt guide 7. In this case, the tongue 5 is slidably supported by the seatbelt 4, similarly to the case of a tongue in the related art.

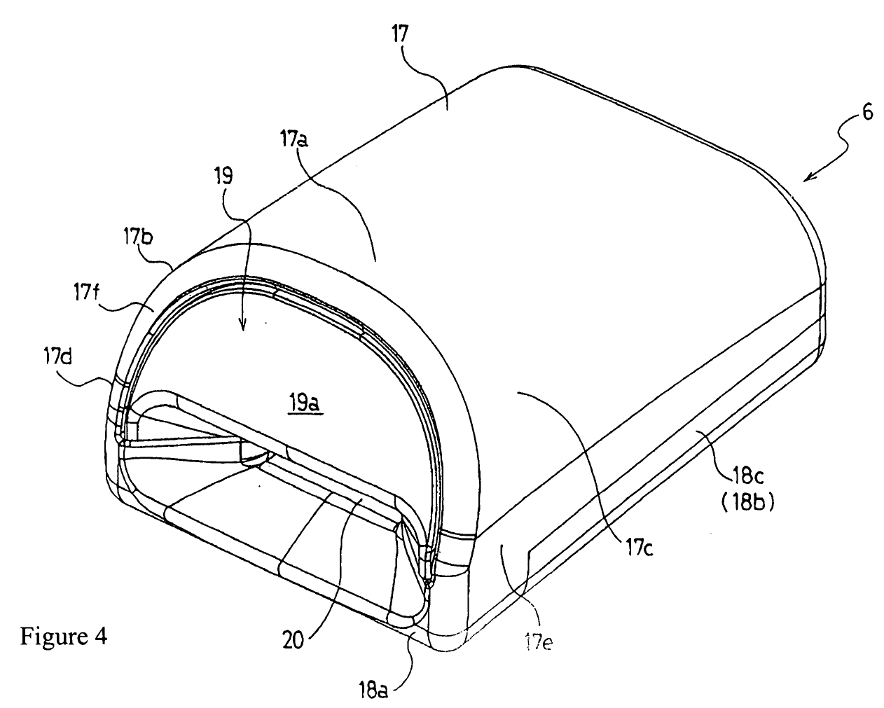

An example of a buckle 6 that is inserted into and engaged with the tongue 5 according to this embodiment is shown in FIG. 4. As shown in FIG. 4, the buckle 6 may include a cover with an upper cover 17 and a lower cover 18. The upper cover may include an upper surface 17a formed in relatively flat shape in contour and left and right side wall portions 17d, 17e connected to the upper surface 17a respectively through R portions 17b, 17c of relatively large diameter, and is formed into a semi-cylindrical shape. The lower cover 18 may include a flat bottom portion 18a, and left and right side wall portions 18b, 18c formed on both of the left and right side edges of the bottom portion 18a so as to extend in the vertical direction, and is formed into a U-shape in lateral cross section (although the left side wall portion 18b is not shown in FIG. 4, the reference numeral 18b is shown adjacently to the reference numeral 18c in parenthesis for the convenience of description).

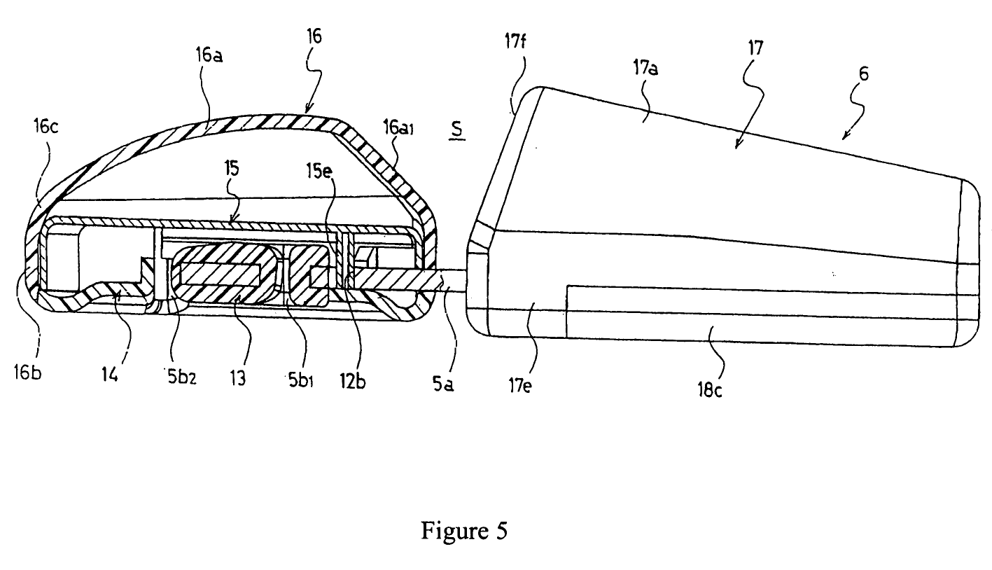

Then, the left and right wall portions 17d, 17e of the upper cover and the left and right side wall portions 18b, 18c of the lower cover 18 may be aligned respectively in the vertical direction, and then the upper cover 17 and the lower cover 18 may be detachably engaged by, for example, snap engagement or the like, whereby generally cylindrical cover is formed. As shown in FIG. 5, the end surface 17f of the upper cover 17 on the side of the insertion of the tongue 5 may be formed into an inclined surface which extends away from the tongue 5 from the lower portion to the upper portion thereof.

As shown in FIG. 4, the upper cover 17 and the lower cover 18 engaged with respect to each other may be formed into a cylindrical shape, and a release button 19 is provided on the side of the upper cover 17 inside the cylinder, and a tongue insertion port 20 is provided between the release button 19 and the lower cover 18. In this case, the side surface 19a of the release button 19 on the tongue 5 side is also inclined along the end surface 17f of the upper cover 17. Although not shown, since the latch structure of the buckle 6 is substantially the same as that of the buckle in the related art, and does not have a characteristic part which relates directly to the tongue 5 in the present invention, the description thereof will be omitted.

As shown in FIG. 5, the tongue 5 and the buckle 6 in this arrangement are engaged with each other by inserting the engaging strip 5a into the tongue insertion port 20, thereby engaging the latch member of the buckle 6 with the engaging hole 5a1 of the engaging strip 5a, as in the case of the tongue in the related art. In the state in which the tongue 5 and the buckle 6 are engaged in this manner, since the upper cover 16 of the tongue 5 is provided with the upper surface portion 16a1 which may have a flat inclined planar-shape, even when the upper surface portion 16a of the upper cover 16 is formed so as to swell upward, a relatively large space S is defined. Therefore, when the passenger presses the release button 19 for releasing the tongue 5 from the buckle 6, he/she can insert his/her finger into the space S easily. Accordingly, the pressing operation of the release button 19 can be performed easily and reliably.

In particular, in this embodiment, since the end surface 17f of the upper cover 17 of the buckle 6 and the end surface 19a of the release button 19 on the tongue 5 side is inclined so as to open upward with respect to the inclined surface of the upper surface portion 16a1 of the upper cover 16, the space S is a relatively large space. Accordingly, a releasing operation of the release button 19 by the finger is further facilitated. In addition, because the space S is interposed between the both upper covers 16, 17, the release button 19 is hardly interfered with an object, thereby preventing accidental release of engagement between the tongue 5 and the buckle 6 are engaged.

With the tongue 5 of this embodiment, since the upper surface portion 16a of the gripper 5b of the tongue 5 may be swelled upward in the spherical shape, it can be fitted to the palm of the passenger. Since the outer peripheral surface of the gripper 5b may be formed by the arcuate flange 16b, it can be fitted to the arcuate shape formed by the respective two joints of the four fingers and one joint of the thumb of the passenger, respectively. In addition, since the portion between the upper surface portion 16a and the flange 16b of the gripper 5b is the R-portion 16c, the R-portion 16c can be fitted to the five respective fingers when they are moderately bent. Accordingly, the entire gripper 5b of the tongue 5 can be formed into a contour which can be gripped by the passenger's hand without giving a feeling of discomfort.

Since the inclined upper surface portion 16a1 of the gripper 5b may be inclined toward the swelling direction of the spherical shape away from the engaging strip 5a, the relatively large space S can be defined between the curved swelling portion of the gripper 5b of the tongue 5 and the buckle 6 in a state in which the tongue 5 is inserted into and engaged with the buckle 6. Therefore, when the passenger presses the release button 19 of the buckle 6 for releasing engagement of the tongue 5 from the buckle 6, the passenger can easily insert his/her finger into the space S. Accordingly, even when the gripper 5b of the tongue 5b is formed into the spherical shape, the pressing operation of the release button 19 can be performed easily and reliably.

Because the contour of the gripper 5b of the tongue 5 may be formed generally into a round shape, the tongue 5 gives an appearance of being soft and sedate, whereby the appearance of the gripper 5b can be improved.

In addition, because the upper cover 16 may be formed separately from other components and may be detachably provided, by providing a number of the upper covers 16 having various shapes of the spherical surface and the arc of the outer peripheral surface, the tongue 5 with the gripper 5b which most fits the passenger's hand can be obtained, and the tongue 5 with the gripper 5b which meets the taste of passengers can be also obtained.

Furthermore, because the middle cover 15 for covering the resin molded portion 13 may be opaque, the resin molded portion 13 and the seat belt 4 passing through the two belt through holes 5b1, 5b2 may be hidden from the eyes, and the appearance of the gripper 5b can further be improved. Furthermore, because the upper cover 16 may be transparent so that the upper surface of the upper surface portion 15a of the middle cover 15 can be seen, by providing the emblem or drawing patterns thereon, the appearance of the gripper 5b can further be improved.

Moreover, because the passenger seated on a vehicle seat 2 can easily grip the tongue 5 by employing the tongue 5 of this embodiment as the tongue 5 of the seatbelt apparatus, insertion and engagement of the tongue 5 into/with the buckle 6 by the passenger is facilitated.

In the embodiment shown above, the upper surface portion 16a of the gripper 5b of the tongue 5 may be formed into the spherical shape, and the outer peripheral surface of the gripper 5b may be formed into the arcuate shape. However, the present invention is not limited thereto, and it is also possible to form the upper surface portion 16a into a curved surface of curved swelling, such as an egg shape, and the outer peripheral surface of the gripper 5b may be formed into a curved arc such as the oval arcuate shape. Forming the curved surface of the curved swelling shape of the gripper 5b into a spherical shape allows the gripper 5b to effectively fit to the passenger's hand, since the human palm is substantially close to the spherical shape.

The tongue 5 of this embodiment can be used for the safety belt apparatus, for example, for personnel in a work site or for equipment used in a work site, and the same effects can be obtained.

The tongue of the present invention can be used effectively as a tongue used in the seatbelt for a passenger seated on the seat of the vehicle, such as the motor vehicle, and in the safety belt apparatus for personnel in a work site or the like.

The priority application, Japanese Patent Application No. 2004-322216 filed on Nov. 5, 2004, is hereby incorporated by reference herein in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A seat belt tongue, comprising:
a gripper and an engaging strip projecting from the gripper, wherein the gripper is arranged to be slidably supported by a safety belt, wherein the engaging strip is arranged to be inserted into and engaged with a buckle;
wherein a portion of an outer peripheral surface of the gripper is formed into a curved arc, wherein a second portion of the outer peripheral surface is arranged so that the engaging strip projects from the second portion, wherein the second portion is formed into a chord that is continued from the curved arc;
wherein a surface of the gripper forms a curved surface of a curved swelling shape and a planer surface formed continuously from the curved surface, and
wherein the curved surface is provided on a portion formed continuously from the outer peripheral surface formed into the shape of the curved arc, and the planer surface is formed to be continued from the outer peripheral surface formed into the linear chord and to be inclined from the outer peripheral surface formed into the chord toward the swelling direction of the curved surface and away from the engaging strip.

2. The seat belt tongue of claim 1, wherein the curved arc on the outer peripheral surface of the gripper is a circular arc, and the curved surface is a spherical surface.

3. A seat belt tongue comprising:
a metallic T-shaped tongue plate including an engaging strip and a through hole for a safety belt and a resin molded portion, wherein the resin molded portion is molded on a portion of the tongue plate with the through hole;
a lower cover arranged to support the resin molded portion and the tongue plate; and
an upper cover arranged to detachably engage with the lower cover so as to cover the resin molded portion.

4. The seat belt tongue of claim 3, wherein a surface of the upper cover on one side forms a curved surface of a curved swelling shape and a planer surface formed continuously from the curved surface, and
wherein the curved surface is provided on a portion formed continuously from an outer peripheral surface of the upper cover that is formed into a curved arc, and the planar surface is formed to be continued from an outer peripheral surface formed into a linear chord and inclined from the outer peripheral surface formed into the chord toward a swelling direction of the curved surface and away from the engaging strip.

5. The seat belt tongue of claim 3, further comprising a middle cover formed of opaque material is provided to cover the resin molded portion;
wherein the upper cover is provided so as to cover the middle cover, wherein the upper cover is formed of a transparent material.

6. The seat belt tongue of claim 5, wherein an upper surface portion of the middle cover has an arcuate outer peripheral edge formed with an arcuate flange, wherein the flange is arranged to contact an outer peripheral end of an upper surface of the lower cover.

7. The seat belt tongue of claim 6, wherein a portion of the outer peripheral edge forms a chord shape that includes a flange.

8. The seat belt tongue of claim 7, wherein the flange includes a notch arranged so that the engaging strip fits within the notch.

9. The seat belt tongue of claim 5, wherein the middle cover includes a cylindrical column that is arranged to fit into and engage with an engaging hole formed in the tongue plate.

10. The seat belt tongue of claim 5, wherein the upper cover is arranged to be mounted to the lower cover so that the middle cover is between the upper cover and the lower cover.

11. The seat belt tongue of claim 3, wherein an upper surface portion of the upper cover is formed into a spherical shape that swells upwards, wherein an arcuate flange of the upper cover is continuously formed on an arcuate outer peripheral edge in a vertical direction, wherein the upper surface portion is sized to fit an average size of a human palm.

12. The seat belt tongue of claim 3, wherein an outer peripheral edge of an upper surface portion of the upper cover is formed into a chord shape that includes a flange.

13. The seat belt tongue of claim 12, wherein the flange includes a recess arranged so that the engaging strip fits within the recess.

14. The seat belt tongue of claim 3, wherein the tongue plate and the resin molded portion form a first through hole to allow passage of a seat belt through the tongue plate.

15. The seat belt tongue of claim 14, wherein a second through hole is formed between an edge of the resin molded portion and a guide portion of the lower cover, wherein the edge of the resin molded portion is an opposite side of the tongue plate from the engaging strip.

16. The seat belt tongue of claim 15, wherein the seat belt tongue is arranged to allow passage of a seat belt through the first through hole, through a space formed between an upper surface portion of the middle cover and the resin molded portion, and through the second through hole.

17. A seat belt apparatus comprising:
a seatbelt;
a seatbelt retractor for retracting the seatbelt;
a tongue slidably supported by the seatbelt; and
a buckle, wherein the tongue is arranged to be inserted and engaged with the buckle, wherein the seat belt is arranged to be fastened on a passenger when the tongue is inserted into and engaged with the buckle;
wherein the tongue includes a tongue plate that includes an engaging strip and a through hole for a safety belt and a resin molded portion, wherein the resin molded portion is molded on a portion of the tongue plate with the through hole, wherein the tongue plate is formed into a T-shape;
a lower cover arranged to support the resin molded portion and the tongue plate; and
an upper cover arranged to detachably engage with the lower cover so as to cover the resin molded portion.

18. The seat belt apparatus of claim 17, wherein a surface of the upper cover on one side forms a curved surface of a curved swelling shape and a planer surface formed continuously from the curved surface, and
wherein the curved surface is provided on a portion formed continuously from an outer peripheral surface of the upper cover that is formed into a curved arc, and the planar surface is formed to be continued from an outer peripheral surface formed into a linear chord and inclined from the outer peripheral surface formed into the chord toward a swelling direction of the curved surface and away from the engaging strip.

19. A seat belt tongue comprising:
a metallic T-shaped tongue plate including an engaging strip and a through hole for a safety belt and a resin molded portion, wherein the resin molded portion is molded on a portion of the tongue plate with the through hole;
wherein the tongue plate is located between detachably engaged upper and lower covers;
wherein a top surface of the upper cover is dome shaped, and wherein a portion of the dome shaped top surface is truncated by an angled planar surface extending from the perimeter of the upper cover upwards toward the peak of the dome shaped surface.
